(19) United States
(12) Patent Application Publication
(10) Pub. No.: US 2019/0277225 A1
(43) Pub. Date: Sep. 12, 2019

(54) EXHAUST GAS RECIRCULATION SYSTEM FOR GASOLINE ENGINE AND CONTROL METHOD THEREOF

(71) Applicant: GUANGZHOU AUTOMOBILE GROUP CO., LTD., Guangzhou, Guangdong (CN)

(72) Inventors: Hong Chen, Guangzhou, Guangdong (CN); Yuhuai Li, Guangzhou, Guangdong (CN); Hainian Lian, Guangzhou, Guangdong (CN); Yancai Chen, Guangzhou, Guangdong (CN); Lin Ye, Guangzhou, Guangdong (CN); Qizhou Zhang, Guangzhou, Guangdong (CN)

(21) Appl. No.: 16/311,811

(22) PCT Filed: Jul. 11, 2018
(86) PCT No.: PCT/CN2018/095330

§ 371 Date: Dec. 20, 2018

(30) Foreign Application Priority Data
Dec. 20, 2017 (CN) 201711383752.0

(51) Int. Cl. F02M 26/10; F02M 35/10; F02M 26/19

(52) U.S. Cl. CPC F02M 26/10; F02M 2026/001; F02M 26/19; F02M 35/10118

(57) ABSTRACT

An exhaust gas recirculation system for gasoline engine includes a first exhaust gas return tube, a high-pressure by-pass tube, a second exhaust gas return tube and an EGR control unit. The first exhaust gas return tube includes a hot end, a cold end, a high-pressure EGR cooler, and a high-pressure EGR valve. The high-pressure by-pass tube connected with the first exhaust gas return tube in parallel has a high-pressure EGR by-pass valve. The second exhaust gas return tube has a hot end, a cold end, a low-pressure EGR cooler, a low-pressure EGR valve and a low-pressure EGR pump. The EGR control unit is electrically connected with the high-pressure EGR valve, the high-pressure EGR by-pass valve, the low-pressure EGR valve and the low-pressure EGR pump respectively. Different EGR recirculation manners can be chosen under different loads and different running conditions of the gasoline engine to meet different demands under different conditions.

### FIELD OF THE INVENTION

The present disclosure relates to technical field of exhaust gas recirculation and, more particularly to an exhaust gas recirculation system for gasoline engine and a control method thereof.

### BACKGROUND OF THE INVENTION

In the control technology of the existing engine combustion process, the increase in the power and the economy of the gasoline engine is limited by knockings, and the emission of nitrogen oxides is generated during the combustion of the gasoline engine. Exhaust Gas Recirculation (EGR) cools the in-cylinder combustion process, lowers the maximum combustion temperature, limits the occurrence of knockings while increasing the thermal efficiency of the gasoline engine, and effectively reduces nitrogen oxides (NOx) emissions.

Variable Nozzle Turbo (VNT) can control the exhaust back pressure by adjusting the opening degree of the nozzle ring, and venturi tube arranged in the intake duct can control the intake pressure. The combination of various technical means can effectively improve the exhaust gas recirculation rate, increase the amount of recirculated exhaust gas involved in combustion, and effectively reduce nitrogen oxide emissions. However, this single high-pressure cold EGR cannot achieve high-pressure hot EGR, and cannot improve the economical efficiency of the partial load of the gasoline engine. At the same time, a single high-pressure EGR system cannot achieve EGR when the gasoline engine is running at low speed and high load, and the economical efficiency and emissions of the gasoline engine cannot be improved.

At present, the gasoline engine EGR system adopts a separate high-pressure cold EGR circulation system or a low-pressure cold EGR circulation system, which cannot meet the different load and different running conditions of gasoline engines for different EGRs, and limits the potential of the EGR in improving the thermal efficiency of gasoline engines and reducing NOx emissions.

### SUMMARY OF THE INVENTION

To overcome the drawbacks existed in the prior arts, the objective of the present disclosure is to provide an exhaust gas recirculation system for gasoline engine and a control method thereof, whereby different EGR recirculation manners can be chosen under different loads and different running conditions of the gasoline engine so as to meet different demands under different conditions.

The present disclosure provides an exhaust gas recirculation (EGR) system for gasoline engine comprising an intake duct, a turbocharger compressor, an intake intercooler, an intake manifold, a cylinder, an exhaust manifold, a turbocharger turbine connected with the turbocharger compressor, and an exhaust duct, and the system further includes:

a first exhaust gas return tube which has a hot end connected with the exhaust manifold and a cold end connected with the intake manifold, and the first exhaust gas return tube being provided with a high-pressure EGR cooler and a high-pressure EGR valve;

a high-pressure by-pass tube which is connected with the first exhaust gas return tube in parallel, and the high-pressure by-pass tube being provided with a high-pressure EGR by-pass valve;

a second exhaust gas return tube which has a hot end connected with the exhaust duct and a cold end connected with the intake duct, and the second exhaust gas return tube being provided with a low-pressure EGR cooler, a low-pressure EGR valve and a low-pressure EGR pump; and

an EGR control unit which is electrically connected with the high-pressure EGR valve, the high-pressure EGR by-pass valve, the low-pressure EGR valve and the low-pressure EGR pump, respectively.

As a preferable embodiment, a venturi tube is connected between the intake intercooler and the intake manifold, and the cold end of the first exhaust return tube is connected with a throat of the venturi tube.

Preferably, the high-pressure by-pass tube has an air intake end connected with the hot end of the first exhaust gas return tube, and an air outlet end connected with the cold end of the first exhaust gas return tube.

Preferably, a turbocharger that is a variable nozzle turbo is included, and the turbocharger turbine is a variable geometry turbine and electrically connected with the EGR control unit.

The present disclosure further provides a control method of an exhaust gas recirculation system for gasoline engine, comprising:

when an engine is under a steady state running condition with a low load smaller than a preset load, turning on the high-pressure EGR by-pass valve, turning off the high-pressure EGR valve, the low-pressure EGR valve and the low-pressure EGR pump, thereby exhaust gas flowing through the exhaust manifold and the high-pressure by-pass tube to undergo high-pressure hot EGR;

when the engine is under a steady state running condition with a high load higher than the preset load, turning on the low-pressure EGR valve and the low-pressure EGR pump, turning off the high-pressure EGR valve and the high-pressure EGR by-pass valve, thereby exhaust gas flowing through the exhaust duct and the second exhaust gas return tube to undergo low-pressure cold EGR; and

when the engine is under a transient acceleration running condition, turning on the high-pressure EGR valve, the low-pressure EGR valve and the low-pressure EGR pump, and turning off the high-pressure EGR by-pass valve, thereby exhaust gas flowing through the exhaust manifold and the first exhaust gas return tube to undergo high-pressure cold EGR, and meanwhile flowing through the exhaust duct and the second exhaust gas return tube to undergo low-pressure cold EGR.

Further, the control method further includes:

acquiring an engine speed signal and an engine torque signal; and

determining if the engine is under the steady state running condition with a low load smaller than the preset load, the steady state running condition with a high load higher than the preset load, or the transient acceleration running condition, accordingly to the engine speed signal and the engine torque signal.

Further, a turbocharger that is a variable nozzle turbo is used, and the turbocharger turbine is a variable nozzle area turbine, and the control method further comprises:

controlling an opening degree of the turbocharger turbine to reach the maximum, when the engine is under the steady state running condition with low load smaller than the preset load;

controlling the opening degree of the turbocharger turbine to be smaller than the maximum, when the engine is under the steady state running condition with high load smaller than the preset load;

controlling the opening degree of the turbocharger turbine to be smaller than the maximum, when the engine is under the transient acceleration running condition.

Preferably, the preset load is 25% of a full load of the gasoline engine.

In comparison with the prior art, the EGR system of the present disclosure can meet different demands for exhaust gas recirculation under different loads and different running conditions of the gasoline engine. When the gasoline engine is running under different loads, high-pressure EGR, low-pressure EGR, cold EGR, hot EGR, or mixed recirculation of high-pressure cold EGR and low-pressure cold EGR can be controlled and chosen, thus the thermal efficiency of the gasoline engine is improved, and the emission of NOx is reduced.

### BRIEF DESCRIPTION OF THE DRAWINGS

FIG. 1 is a schematic diagram of an exhaust gas recirculation system for gasoline engine according to one embodiment of the present disclosure; and

FIG. 2 is a schematic diagram of a control method of an exhaust gas recirculation system for gasoline engine according to one embodiment of the present disclosure.

### DETAILED DESCRIPTION OF ILLUSTRATED EMBODIMENTS

To further explain the technical means and effects of the present invention, the present invention will be described in detail below with reference to the accompanying drawings and preferred embodiments.

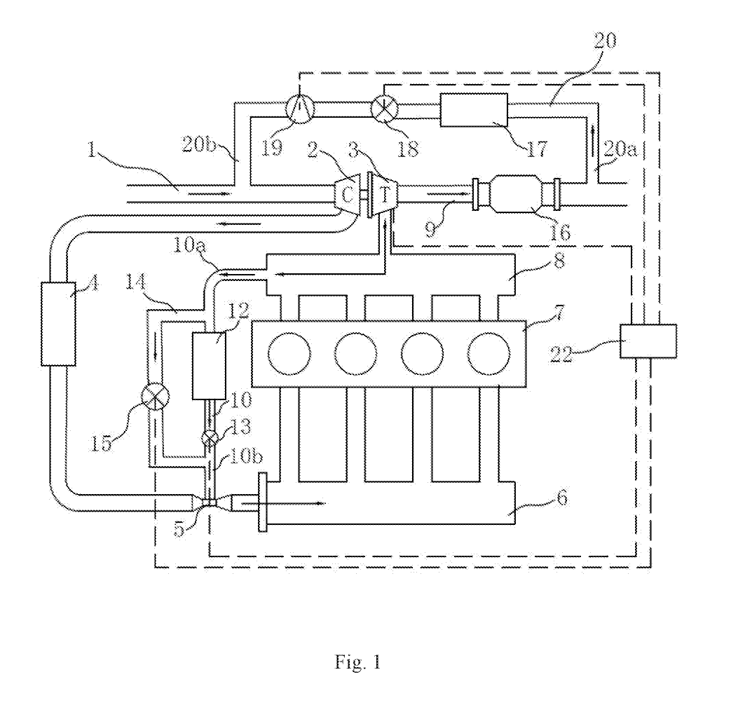

Referring to FIG. 1, the exhaust gas recirculation (EGR) system for gasoline engine accordingly to the present embodiment is applicable to engines equipped with turbochargers which include turbocharger compressors and turbocharger turbines. The EGR system for gasoline engine includes an intake duct 1, a turbocharger compressor 2, an intake intercooler 4, an intake manifold 6, a cylinder 7, an exhaust manifold 8, a turbocharger turbine 3 and an exhaust duct 9, the turbocharger turbine 3 is connected with the turbocharger compressor 2, and the exhaust duct 9 is provided with a three-way catalyst 16.

Specifically, the EGR system further includes:

a first exhaust gas return tube 10 which has a hot end 10a connected with the exhaust manifold 8 and a cold end 10b connected with the intake manifold 6, and the first exhaust gas return tube 10 providing with a high-pressure EGR cooler 12 and a high-pressure EGR valve 13;

a high-pressure by-pass tube 14 which is connected with the first exhaust gas return tube 10 in parallel, and the high-pressure by-pass tube 14 providing with a high-pressure EGR by-pass valve 15;

a second exhaust gas return tube 20 which has a hot end 20a connected with the exhaust duct 9 and a cold end 20b connected with the intake duct 1, and the second exhaust gas return tube 20 providing with a low-pressure EGR cooler 17, a low-pressure EGR valve 18 and a low-pressure EGR pump 19; and

an EGR control unit 22 which is electrically connected with the high-pressure EGR valve 13, the high-pressure EGR by-pass valve 15, the low-pressure EGR valve 18 and the low-pressure EGR pump 19, respectively.

Further, in the embodiment, the high-pressure by-pass tube 14 has an air intake end connected with the hot end 10a of the first exhaust gas return tube, and an air outlet end connected with the cold end 10b of the first exhaust gas return tube. In other embodiment, the air intake end and the air outlet end of the high-pressure by-pass tube 14 can be connected with the exhaust duct 9 and the intake manifold 6 respectively.

In this embodiment, a venturi tube 5 is connected between the intake intercooler 4 and the intake manifold 6, which has an air intake connected with the intake duct 1 and an air outlet connected with the intake manifold 6. Further, the cold end 10b of the first exhaust return tube 10 is connected with a throat of the venturi tube 5. By means of the venturi tube 5, the pressure of the throat is adjustable, thus the EGR rate is improved.

Specifically, the turbocharger in the present embodiment is a variable nozzle turbo (VNT), and the turbocharger turbine 3 is a variable geometry turbine and electrically connected with the EGR control unit 22. By means of the EGR control unit 22, the opening degree of guide vanes of the turbocharger turbine 3 can be controlled, therefore air flow and flow speed flowing through the guide vanes of the turbocharger turbine 3 can be controlled accordingly.

During high-pressure cold exhaust gas recirculation, after the exhaust gas of the gasoline flows through the exhaust manifold 8, the high-pressure EGR cooler 12 and the first exhaust gas return tube 10, the exhaust gas together with fresh air coming from the intake duct 1 then goes into the intake manifold 6, under control of the high-pressure EGR valve 13.

During high-pressure hot exhaust gas recirculation, exhaust gas from the hot end of the first exhaust gas return tube 10 directly flows through the high-pressure by-pass tube 14, without through the high-pressure EGR cooler 12, and then the exhaust gas together with fresh air coming from the intake duct 1 go into the intake manifold 6, under control of the venturi tube 5.

During low-pressure cold exhaust gas recirculation, exhaust gas from the three-way catalyst 16 flows through the second exhaust gas return tube 20 and the low-pressure EGR cooler 17, and then goes into the intake duct 1 arranged before the turbocharger compressor 2, under controls of the low-pressure EGR valve 18 and the low-pressure pump 19.

In this embodiment, the venturi tube 5 is utilized, thus difference between the exhaust pressure of the turbocharger and the intake pressure of the throat of the venturi tube 5 is increased, under a condition of the intake pressure of the gasoline engine is maintained. Due to the turbocharger turbine 3 is a variable geometry turbine, thus the pressure on the turbocharger turbine 3 is improved partly. By combination with the both mentioned above, a Variable Nozzle Turbo+venturi-Exhaust Gas Recirculation (VNT+vEGR) system is formed.

When the gasoline engine is under different loadings and different operation conditions, the operations of the EGR valve 13, the high-pressure EGR by-pass valve 15, the low-pressure EGR valve 18 and the low-pressure EGR pump 19 can be controlled by the EGR control unit 22, thereby achieving different EGR manners. Further, the opening degree of the turbocharger turbine can be controlled by the EGR control unit 22, thus the thermal efficiency is improved and NOx discharging is optimized.

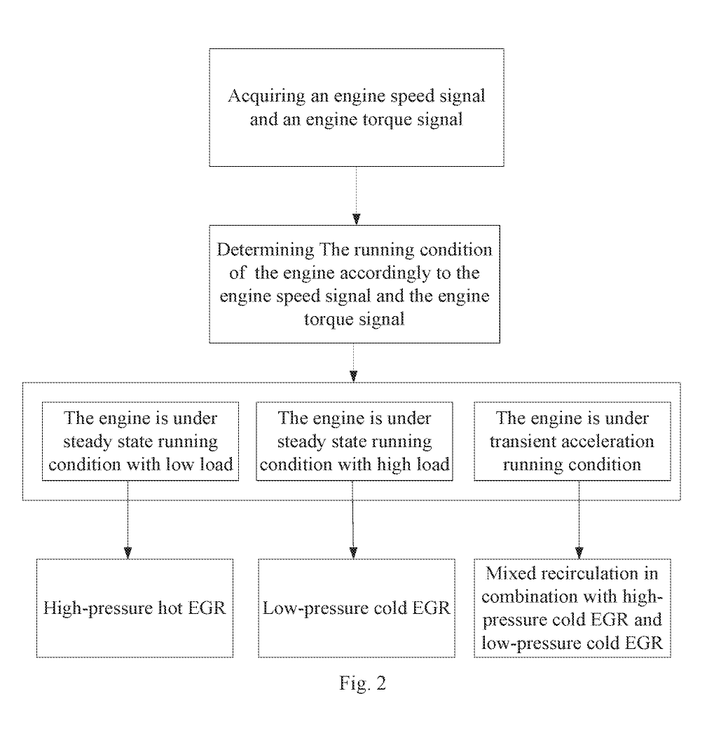

Furthermore, as shown in FIG. 2, the present disclosure provides a control method of an EGR system for gasoline engine, for controlling the EGR system mentioned above.

The control method includes:

when an engine is under steady state running condition with a low load smaller than a preset load, turning on the high-pressure EGR by-pass valve 15, and turning off the high-pressure EGR valve 13, the low-pressure EGR valve 18 and the low-pressure EGR pump 19, thereby the exhaust gas flowing through the exhaust manifold 8 and the high-pressure by-pass tube 14 to undergo high-pressure hot EGR;

when the engine is under steady state running condition with a high load higher than the preset load, turning on the low-pressure EGR valve 18 and the low-pressure EGR pump 19, and turning off the high-pressure EGR valve 13 and the high-pressure EGR by-pass valve 15, thereby the exhaust gas flowing through the exhaust duct 9 and the second exhaust gas return tube 20 to undergo low-pressure cold EGR;

when the engine is under transient acceleration running condition, turning on the high-pressure EGR valve 13, the low-pressure EGR valve 18 and the low-pressure EGR pump 19, and turning off the high-pressure EGR by-pass valve 15, thereby the exhaust gas flowing through the exhaust manifold 8 and the first exhaust gas return tube 10 to undergo high-pressure cool EGR and meanwhile flowing through the exhaust duct 9 and the second exhaust gas return tube 20 to undergo low-pressure cold EGR.

Specifically, the turn-on and turn off for the components mentioned above are controlled by the EGR control unit 22.

Further, the control method includes:

acquiring an engine speed signal and an engine torque signal; and

determining if the engine is under the steady state running condition with the low load smaller than the preset load, the steady state running condition with the high load higher than the preset load, or the transient acceleration running condition, accordingly to the engine speed signal and the engine torque signal.

When the engine is under steady state running condition with low load, the intake air amount in the cylinder 7 is small, and the temperature in the cylinder 7 is low, thus a high-pressure hot EGR can increase temperature in the cylinder which is beneficial to fuel oil atomization in the cylinder 7, so that the thermal efficiency is improved to reduce NOx emission. During the high-pressure hot EGR, the high-pressure EGR by-pass valve 15 is turned on, and the high-pressure EGR valve 13, the low-pressure EGR valve 18 and the low-pressure EGR pump 19 are turned off, so that a part of the exhaust gas from the exhaust manifold 8 flows through the hot end 10a of the first exhaust return tube 10, the high-pressure by-pass tube 14 and the high-pressure EGR by-pass valve 15, the cold end 10b of the first exhaust return tube 10 and the venturi tube 5 and finally goes into the intake manifold 6; and the rest exhaust gas flows through the exhaust duct 9 and the three-way catalyst 16 to discharge.

When the engine is under steady state running condition with high load, the temperature in the cylinder 7 is high, which may bring knockings, thus a low-pressure cold EGR can decrease the temperature in the cylinder 7, so that the thermal efficiency is improved to reduce NOx emission, and the lifetime of the engine is extended. During the low-pressure cold EGR, the high-pressure EGR valve 13 and the high-pressure EGR by-pass valve 15 are turned off, and the low-pressure EGR valve 18 and the low-pressure EGR pump 19 are turned on, so that a part of the exhaust gas from the exhaust manifold 8 flows through the hot end 20a of the second exhaust gas return tube 20, the low-pressure EGR cooler 17, the low-pressure EGR valve 18, the low-pressure EGR pump 19 and the cold end 20b of the second exhaust gas return tube 20 and finally goes into the intake induct 1; and the rest exhaust gas flows through the exhaust duct 9 and the three-way catalyst 16 to discharge.

When the engine is under transient acceleration running condition, the speed of the engine is required to be increased, a single low-pressure cold EGR may not satisfy the demand, since the pipeline is long to bring slow response time and insufficient torque; as well, a single high-pressure cold EGR may cause intake air amount in the cylinder insufficient. Thus a mixed recirculation in combination with the high-pressure cold EGR and the low-pressure cold EGR is developed to solve the above issue. Specifically, when the mixed recirculation is performed, the high-pressure EGR by-pass valve 15 is turned off, and the high-pressure EGR valve 13, the low-pressure EGR valve 18 and the low-pressure EGR pump 19 are turned off, so that a first part of the exhaust gas from the exhaust manifold 8 flows through the hot end 10a of the first exhaust gas return tube 10, the high-pressure cooler 12, the high-pressure EGR valve 13, the cold end 10b of the first exhausting return tube 10 and the venturi tube 5 and finally goes into the intake manifold 6; and a second part of exhaust gas flows through the hot end 20a of the second exhaust gas return tube 20, the low-pressure EGR cooler 17, the low-pressure EGR valve 18, the low-pressure EGR pump 19 and the cold end 20b of the second exhaust gas return tube 20 and finally goes into the intake induct 1; and the rest exhaust gas flows through the exhaust duct 9 and the three-way catalyst 16 to discharge.

Furthermore, when the engine is under the steady state running condition with low load smaller than the preset load, the opening degree of the turbocharger turbine 3 is control to reach the maximum.

When the engine is under the steady state running condition with high load smaller than the preset load, the opening degree of the turbocharger turbine 3 is control to be smaller than the maximum.

When the engine is under the transient acceleration running condition, the opening degree of the turbocharger turbine 3 is control to be smaller than the maximum.

In the present embodiment, the preset load 25% of a full load of the gasoline engine, but other percents can be chosen, accordingly to the operating characteristic of the engine.

It can be understood that the engine load refers to the ratio of the current power of the engine at a certain speed and the maximum power of the engine that can be emitted at the same speed.

As known, the opening degree of the guide vanes of the turbocharger turbine 3 can affect the air flow speed guided to the turbocharger turbine 3. When the engine is running at a low speed, the nozzle ring cross-sectional area is reduced, the turbine speed is increased, and the boost pressure is increased to ensure the boost pressure and the intake air amount required under the low engine speed; when the engine is running at a high speed, the nozzle ring cross-sectional area is increased, the turbine speed is decreased to prevent overspeed of the supercharger; when the engine is accelerating, in order to increase the response speed of the supercharger, the nozzle ring cross-sectional area can be reduced, and the speed of the supercharger is increased, thereby increasing the boost pressure and the intake air amount to meet the intake requirements during the transient operation.

The control method of the gasoline engine exhaust gas recirculation system provided by the embodiment can make the gasoline engine adopt different EGR circulation modes under different loads and different running conditions, and realize the low pressure cold EGR and high-pressure cold EGR mixed recirculation to optimize of the EGR rate and improve the EGR responsiveness, thereby improving thermal efficiency and optimizing NOx emissions.

While the disclosure has been described in connection with what are presently considered to be the most practical and preferable embodiments, it is to be understood that the disclosure is not to be limited to the disclosed embodiments, but on the contrary, is intended to cover various modifications and equivalent arrangements included within the spirit and scope of the disclosure.

The control method of the gasoline engine exhaust gas recirculation system provided by the embodiment can make the gasoline engine adopt different EGR circulation modes under different loads and different running conditions, and realize the low pressure cold EGR and high-pressure cold EGR mixed recirculation to optimize of the EGR rate and improve the EGR responsiveness, thereby improving thermal efficiency and optimizing NOx emissions.

1. An exhaust gas recirculation (EGR) system for gasoline engine, comprising an intake duct (1), a turbocharger compressor (2), an intake intercooler (4), an intake manifold (6), a cylinder (7), an exhaust manifold (8), a turbocharger turbine (3) connected with the turbocharger compressor (2), and an exhaust duct (9), the exhaust gas recirculation system further comprising:
a first exhaust gas return tube (10) which has a hot end (10a) connected with the exhaust manifold (8) and a cold end (10b) connected with the intake manifold (6), the first exhaust gas return tube (10) being provided with a high-pressure EGR cooler (12) and a high-pressure EGR valve (13);
a high-pressure by-pass tube (14) which is connected with the first exhaust gas return tube (10) in parallel, and the high-pressure by-pass tube (14) being provided with a high-pressure EGR by-pass valve (15);
a second exhaust gas return tube (20) which has a hot end (20a) connected with the exhaust duct (9) and a cold end (20b) connected with the intake duct (1), and the second exhaust gas return tube (20) being provided with a low-pressure EGR cooler (17), a low-pressure EGR valve (18) and a low-pressure EGR pump (19); and
an EGR control unit (22) which is electrically connected with the high-pressure EGR valve (13), the high-pressure EGR by-pass valve (15), the low-pressure EGR valve (18) and the low-pressure EGR pump (19), respectively.

2. The exhaust gas recirculation system for gasoline engine according to claim 1, wherein a venturi tube (5) is connected between the intake intercooler (4) and the intake manifold (6), and the cold end (10b) of the first exhaust return tube (10) is connected with a throat of the venturi tube (5).

3. The exhaust gas recirculation system for gasoline engine according to claim 1, wherein the high-pressure by-pass tube (14) has an air intake end connected with the hot end (10a) of the first exhaust gas return tube, and an air outlet end connected with the cold end (10b) of the first exhaust gas return tube.

4. The exhaust gas recirculation system for gasoline engine according to claim 2, wherein a turbocharger that is a variable nozzle turbo is included, and the turbocharger turbine (3) is a variable geometry turbine and electrically connected with the EGR control unit (22).

5. A control method of the exhaust gas recirculation system for gasoline engine according to claim 1, the control method comprising:
when an engine is under a steady state running condition with a low load smaller than a preset load, turning on the high-pressure EGR by-pass valve (15), and turning off the high-pressure EGR valve (13), the low-pressure EGR valve (18) and the low-pressure EGR pump (19), thereby exhaust gas flowing through the exhaust manifold (8) and the high-pressure by-pass tube (14) to undergo high-pressure hot EGR;
when the engine is under a steady state running condition with a high load higher than the preset load, turning on the low-pressure EGR valve (18) and the low-pressure EGR pump (19), and turning off the high-pressure EGR valve (13) and the high-pressure EGR by-pass valve (15), thereby exhaust gas flowing through the exhaust duct (9) and the second exhaust gas return tube (20) to undergo low-pressure cold EGR; and
when the engine is under a transient acceleration running condition, turning on the high-pressure EGR valve (13), the low-pressure EGR valve (18) and the low-pressure EGR pump (19), and turning off the high-pressure EGR by-pass valve (15), thereby exhaust gas flowing through the exhaust manifold (8) and the first exhaust gas return tube (10) to undergo high-pressure cold EGR, and meanwhile flowing through the exhaust duct (9) and the second exhaust gas return tube (20) to undergo low-pressure cold EGR.

6. The control method according to claim 5, further comprising:
acquiring an engine speed signal and an engine torque signal; and
determining if the engine is under the steady state running condition with a low load smaller than the preset load, the steady state running condition with a high load higher than the preset load, or the transient acceleration running condition, accordingly to the engine speed signal and the engine torque signal.

7. The control method according to claim 5, wherein a turbocharger that is a variable nozzle turbo is used, and the turbocharger turbine (3) is a variable nozzle area turbine, and the control method further comprises:
controlling an opening degree of the turbocharger turbine to reach a maximum, when the engine is under the steady state running condition with a low load smaller than the preset load;
controlling the opening degree of the turbocharger turbine to be smaller than the maximum, when the engine is under the steady state running condition with a high load smaller than the preset load;
controlling the opening degree of the turbocharger turbine to be smaller than the maximum, when the engine is under the transient acceleration running condition.

8. The control method according to claim 5, wherein the preset load is 25% of a full load of the gasoline engine.
